(19) United States
(12) Patent Application Publication
(10) Pub. No.: US 2025/0217197 A1
(43) Pub. Date: Jul. 3, 2025

(54) METHOD, COMPUTER DEVICE, AND NON-TRANSITORY COMPUTER-READABLE RECORD MEDIUM FOR PREDICTING AND UTILIZING FUTURE SYSTEM USAGE

(71) Applicant: NAVER CORPORATION, Seongnam-si (KR)

(72) Inventors: Wanho KIM, Seongnam-si (KR); Cheolkyu CHOI, Seongnam-si (KR); Hyoyoung KWAK, Seongnam-si (KR); Jaehoon RYU, Seongnam-si (KR); Eunsuk YANG, Seongnam-si (KR); Jaeboo JEONG, Seongnam-si (KR)

(21) Appl. No.: 18/983,720

(22) Filed: Dec. 17, 2024

(30) Foreign Application Priority Data
Dec. 27, 2023 (KR) 10 2023 0192422

(51) Int. Cl. G06F 9/50

(52) U.S. Cl. CPC G06F 9/5027

(57) ABSTRACT

A future computer system usage forecasting method includes constructing a forecasting model for an input indicator using time series data of the input indicator stored for a first period of time, acquiring a correlation between the input indicator and a system performance indicator using time series data of the input indicator and the system performance indicator stored for a second period of time, forecasting the input indicator associated with at least one future point in time through the forecasting model for the at least one future point in time, and calculating the system performance indicator at the future point in time using the forecasted input indicator and the correlation.

### CROSS-REFERENCE TO RELATED APPLICATION(S)

This U.S. non-provisional application claims the benefit of priority under 35 U.S.C. § 119 to Korean Patent Application No. 10-2023-0192422 filed on Dec. 27, 2023, in the Korean Intellectual Property Office (KIPO), the entire contents of which are incorporated herein by reference.

### BACKGROUND OF THE INVENTION

### Field of Invention

One or more example embodiments of the following description relate to technology for forecasting a system usage.

### Description of Related Art

A cluster refers to a system used for special purposes by connecting an independent computer system, such as a personal computer, to network equipment, and is widely used as a solution to provide high performance computing and high availability computing.

When an upgrade or expansion is required for a computer system, only some nodes or networks may be replaced or added without a need to change the entire computer system, and accordingly, there is an advantage in providing flexible scalability. Due to this advantage, companies, research institutes, and university laboratories that need to execute complex scientific calculation problems are constructing and using clusters to suit their computational requirements.

For each cluster, there is a need for monitoring technology to observe and maintain the normal operation and quality of the clusters.

For example, large-scale cluster monitoring technology that may improve availability at all times by actively responding to configuration information in response to a node failure in a cluster system environment is disclosed in Korean Patent Laid-Open Publication No. 10-2009-0061522 (published on Jun. 16, 2009).

### BRIEF SUMMARY OF THE INVENTION

One or more example embodiments construct a time series forecasting model using unexpected change factors as an input indicator having a correlation with a system performance indicator.

One or more example embodiments calculate a system performance indicator that forecasts an input indicator at a future point in time through a forecasting model, rather than directly forecasting the system performance indicator.

One or more example embodiments use a future system performance indicator in conjunction with a system that automates a resource operation, such as the installation or exclusion of a machine.

According to at least one example embodiment, a forecasting system is provided that uses a forecasting method of a computer device including at least one processor The method includes constructing, by the at least one processor, a forecasting model for an input indicator using time series data of the input indicator that is stored for a first period of time; acquiring, by the at least one processor, a correlation between the input indicator and a system performance indicator using time series data of the input indicator and the system performance indicator stored for a second period of time; forecasting, by the at least one processor, the input indicator at at least one future point in time through the forecasting model for the at least one future point in time; and calculating, by the at least one processor, the system performance indicator at the future point in time using the forecasted input indicator and the correlation.

According to an aspect of the invention, the input indicator may be selected as an indicator of a change for a third period of time that is less than a threshold period of time among indicators to which system resources respond.

According to another aspect of the invention, user traffic corresponding to log data that is input from the outside may be used as the input indicator, and central processing unit (CPU) usage or disk usage may be used as the system performance indicator.

According to still another aspect of the invention, the acquiring of the correlation includes acquiring the correlation between the input indicator and the system performance indicator through a linear regression model.

According to still another aspect of the invention, the acquiring of the correlation may include determining a linear regression coefficient value and a linear regression intercept value through linear regression on time series data of the second period of time.

According to still another aspect of the invention, the linear regression intercept value may be determined as a value close to 0.

According to still another aspect of the invention, the constructing of the forecasting model includes updating the forecasting model using data stored after a previous forecast point in time for the input indicator.

According to still another aspect of the invention, the acquiring of the correlation may include updating the correlation between the input indicator and the system performance indicator at certain time intervals.

According to still another aspect of the invention, the acquiring of the correlation includes acquiring the correlation between the input indicator and the system performance indicator using a value acquired by integrating time series data of the input indicator over time according to a type of the system performance indicator.

According to still another aspect of the invention, the future system usage forecasting method includes recommending, by the at least one processor, a component configuration of the future point in time using the calculated system performance indicator.

According to still another aspect of the invention, the calculating of the system performance indicator at the future point in time includes calculating the system performance indicator at the future point in time for each component constituting a cluster, and the recommending of the component configuration at the future point in time includes calculating and recommending the number of machines of a corresponding component based on the system performance indicator at the future point in time for each component.

According to still another aspect of the invention, the future system usage forecasting method further includes calculating, by the at least one processor, the system performance indicator for each component constituting a new cluster using an input indicator scheduled to be received and the correlation when the input indicator scheduled to be received is given to construct the new cluster; and calculating, by the at least one processor, and recommending the number of necessary machines for each component based on the system performance indicator for each component.

According to still another aspect of the invention, the future system usage forecasting method further includes providing, by the at least one processor, a point in time in the future at which the calculated system performance indicator falls outside a critical value range for the system performance indicator.

According to at least one example embodiment, a non-transitory computer-readable record medium is provided and stores a computer program to execute the future system usage forecasting method on the computer device.

According to another example embodiment, a computer device is provided and includes at least one processor configured to execute computer-readable instructions, where the at least one processor causes the computer device to construct a forecasting model for an input indicator using time series data of the input indicator stored for a first period of time, acquire a correlation between the input indicator and a system performance indicator using time series data of the input indicator and the system performance indicator stored for a second period of time, forecast the input indicator of at least one future point in time through the forecasting model for the at least one future point in time, and calculate the system performance indicator of the future point in time using the forecasted input indicator and the correlation.

According to some example embodiments, it is possible to construct a forecasting model for forecasting a change in an input indicator by training a time series forecasting model to learn an input indicator with few unexpected change factors as an input indicator having correlation with a system performance indicator, thereby reducing outliers in learning data and increasing accuracy of forecasting.

According to some example embodiments, it is possible to easily and simply forecast a future system performance only with an input indicator by forecasting a change in an input indicator through a forecasting model and by calculating a system performance indicator according to correlation using a forecast value of the input indicator, rather than directly forecasting the system performance indicator.

According to some example embodiments, it is possible to stably maintain and manage a system by utilizing a future system performance indicator in conjunction with a system that automates a resources operation, such as installation or exclusion of a machine, and to save operational resources for calculating the number of machines when configuring a new cluster.

Further areas of applicability will become apparent from the description provided herein. The description and specific examples in this summary are intended for purposes of illustration only and are not intended to limit the scope of the present disclosure.

### BRIEF DESCRIPTION OF THE DRAWINGS

Example embodiments will be described in more detail with regard to the figures, where like reference numerals refer to like parts throughout the various figures unless otherwise specified.

FIG. 1 is a diagram illustrating a network environment according to at least one example embodiment of the present invention;

FIG. 2 is a diagram illustrating a computer device according to at least one example embodiment of the present invention;

FIG. 3 illustrates an example of a cluster environment according to at least one example embodiment of the present invention;

FIG. 4 is a flowchart illustrating a method performed by a computer device according to at least one example embodiment of the present invention;

FIGS. 5 and 6 illustrate an input indicator and a system performance indicator according to at least one example embodiment of the present invention;

FIG. 7 is a flowchart illustrating a CPU usage forecasting process according to at least one example embodiment of the present invention;

FIG. 8 illustrates a result of forecasting CPU usage according to at least one example embodiment of the present invention;

FIG. 9 illustrates a configuration file for forecasting resource usage according to at least one example embodiment of the present invention; and

FIGS. 10 to 12 illustrate examples of recommending a component configuration in forecasting resource usage according to at least one example embodiment of the present invention.

It should be noted that these figures are intended to illustrate the general characteristics of methods and/or structure utilized in certain example embodiments and to supplement the written description provided below. These drawings are not, however, to scale and may not precisely reflect the precise structural or performance characteristics of any given embodiment, and should not be interpreted as defining or limiting the range of values or properties encompassed by example embodiments.

### DETAILED DESCRIPTION OF THE INVENTION

One or more example embodiments will be described in detail with reference to the accompanying drawings. Example embodiments, however, may be embodied in various different forms, and should not be construed as being limited to only the illustrated embodiments. Rather, the illustrated embodiments are provided as examples so that this disclosure will be thorough and complete, and will fully convey the concepts of this disclosure to those skilled in the art. Accordingly, known processes, elements, and techniques, may not be described with respect to some example embodiments. Unless otherwise noted, like reference characters denote like elements throughout the attached drawings and written description, and thus descriptions will not be repeated.

Although the terms “first,” “second,” “third,” etc., may be used herein to describe various elements, components, regions, layers, and/or sections, these elements, components, regions, layers, and/or sections, should not be limited by these terms. These terms are only used to distinguish one element, component, region, layer, or section, from another region, layer, or section. Thus, a first element, component, region, layer, or section, discussed below may be termed a second element, component, region, layer, or section, without departing from the scope of this disclosure.

Spatially relative terms, such as “beneath,” “below,” “lower,” “under,” “above,” “upper,” and the like, may be used herein for ease of description to describe one element or feature's relationship to another element(s) or feature s) as illustrated in the figures. It will be understood that the spatially relative terms are intended to encompass different orientations of the device in use or operation in addition to the orientation depicted in the figures. For example, if the device in the figures is turned over, elements described as “below,” “beneath,” or “under,” other elements or features would then be oriented “above” the other elements or features. Thus, the example terms “below” and “under” may encompass both an orientation of above and below. The device may be otherwise oriented (rotated 90 degrees or at other orientations) and the spatially relative descriptors used herein interpreted accordingly. In addition, when an element is referred to as being “between” two elements, the element may be the only element between the two elements, or one or more other intervening elements may be present.

As used herein, the singular forms “a,” “an,” and “the,” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups, thereof. As used herein, the term “and/or” includes any and all combinations of one or more of the associated listed products. Expressions such as “at least one of,” when preceding a list of elements, modify the entire list of elements and do not modify the individual elements of the list. Also, the term “exemplary” is intended to refer to an example or illustration.

When an element is referred to as being “on,” “connected to,” “coupled to,” or “adjacent to,” another element, the element may be directly on, connected to, coupled to, or adjacent to, the other element, or one or more other intervening elements may be present. In contrast, when an element is referred to as being “directly on,” “directly connected to,” “directly coupled to,” or “immediately adjacent to” another element, there are no intervening elements present.

Unless otherwise defined, all terms (including technical and scientific terms) used herein have the same meaning as commonly understood by one of ordinary skill in the art to which example embodiments belong. Terms, such as those defined in commonly used dictionaries, should be interpreted as having a meaning that is consistent with their meaning in the context of the relevant art and/or this disclosure, and should not be interpreted in an idealized or overly formal sense unless expressly so defined herein.

Example embodiments may be described with reference to acts and symbolic representations of operations (e.g., in the form of flow charts, flow diagrams, data flow diagrams, structure diagrams, block diagrams, etc.) that may be implemented in conjunction with units and/or devices discussed in more detail below. Although discussed in a particular manner, a function or operation specified in a specific block may be performed differently from the flow specified in a flowchart, flow diagram, etc. For example, functions or operations illustrated as being performed serially in two consecutive blocks may actually be performed simultaneously, or in some cases be performed in reverse order.

Units and/or devices according to one or more example embodiments may be implemented using hardware and/or a combination of hardware and software. For example, hardware devices may be implemented using processing circuitry such as, but not limited to, a processor, Central Processing Unit (CPU), a controller, an arithmetic logic unit (ALU), a digital signal processor, a microcomputer, a field programmable gate array (FPGA), a System-on-Chip (SoC), a programmable logic unit, a microprocessor, or any other device capable of responding to and executing instructions in a defined manner.

Software may include a computer program, program code, instructions, or some combination thereof, for independently or collectively instructing or configuring a hardware device to operate as desired. The computer program and/or program code may include program or computer-readable instructions, software components, software modules, data files, data structures, and/or the like, capable of being implemented by one or more hardware devices, such as one or more of the hardware devices mentioned above. Examples of program code include both machine code produced by a compiler and higher level program code that is executed using an interpreter.

For example, when a hardware device is a computer processing device (e.g., a processor), Central Processing Unit (CPU), a controller, an arithmetic logic unit (ALU), a digital signal processor, a microcomputer, a microprocessor, etc., the computer processing device may be configured to carry out program code by performing arithmetical, logical, and input/output operations, according to the program code. Once the program code is loaded into a computer processing device, the computer processing device may be programmed to perform the program code, thereby transforming the computer processing device into a special purpose computer processing device. In a more specific example, when the program code is loaded into a processor, the processor becomes programmed to perform the program code and operations corresponding thereto, thereby transforming the processor into a special purpose processor.

Software and/or data may be embodied permanently or temporarily in any type of machine, component, physical or virtual equipment, or computer storage medium or device, capable of providing instructions or data to, or being interpreted by, a hardware device. The software also may be distributed over network coupled computer systems so that the software is stored and executed in a distributed fashion. In particular, for example, software and data may be stored by one or more computer readable storage mediums, including the tangible or non-transitory computer-readable storage media discussed herein.

According to one or more example embodiments, computer processing devices may be described as including various functional units that perform various operations and/or functions to increase the clarity of the description. However, computer processing devices are not intended to be limited to these functional units. For example, in one or more example embodiments, the various operations and/or functions of the functional units may be performed by other ones of the functional units. Further, the computer processing devices may perform the operations and/or functions of the various functional units without sub-dividing the operations and/or functions of the computer processing units into these various functional units.

Units and/or devices according to one or more example embodiments may also include one or more storage devices. The one or more storage devices may be tangible or non-transitory computer-readable storage media, such as random access memory (RAM), read only memory (ROM), a permanent mass storage device (such as a disk drive, solid state (e.g., NAND flash) device, and/or any other like data storage mechanism capable of storing and recording data. The one or more storage devices may be configured to store computer programs, program code, instructions, or some combination thereof, for one or more operating systems and/or for implementing the example embodiments described herein. The computer programs, program code, instructions, or some combination thereof, may also be loaded from a separate computer readable storage medium into the one or more storage devices and/or one or more computer processing devices using a drive mechanism. Such separate computer readable storage medium may include a Universal Serial Bus (USB) flash drive, a memory stick, a Blue-ray/DVD/CD-ROM drive, a memory card, and/or other like computer readable storage media. The computer programs, program code, instructions, or some combination thereof, may be loaded into the one or more storage devices and/or the one or more computer processing devices from a remote data storage device via a network interface, rather than via a local computer readable storage medium. Additionally, the computer programs, program code, instructions, or some combination thereof, may be loaded into the one or more storage devices and/or the one or more processors from a remote computing system that is configured to transfer and/or distribute the computer programs, program code, instructions, or some combination thereof, over a network. The remote computing system may transfer and/or distribute the computer programs, program code, instructions, or some combination thereof, via a wired interface, an air interface, and/or any other like medium.

The one or more hardware devices, the one or more storage devices, and/or the computer programs, program code, instructions, or some combination thereof, may be specially designed and constructed for the purposes of the example embodiments, or they may be known devices that are altered and/or modified for the purposes of example embodiments.

A hardware device, such as a computer processing device, may run an operating system (OS) and one or more software applications that run on the OS. The computer processing device also may access, store, manipulate, process, and create data in response to execution of the software. For simplicity, one or more example embodiments may be exemplified as one computer processing device; however, one skilled in the art will appreciate that a hardware device may include multiple processing elements and multiple types of processing elements. For example, a hardware device may include multiple processors or a processor and a controller. In addition, other processing configurations are possible, such as parallel processors.

Although described with reference to specific examples and drawings, modifications, additions and substitutions of example embodiments may be variously made according to the description by those of ordinary skill in the art. For example, the described techniques may be performed in an order different with that of the methods described, and/or components such as the described system, architecture, devices, circuit, and the like, may be connected or combined to be different from the above-described methods, or results may be appropriately achieved by other components or equivalents.

Hereinafter, some example embodiments will be described with reference to the accompanying drawings.

The example embodiments relate to technology for forecasting computer system usage.

The example embodiments including disclosures herein may calculate a future system performance indicator to provide accurate forecasting for future computer system usage through construction of a forecasting model for forecasting a change in an input indicator by training a time series forecasting model to learn an input indicator with few unexpected change factors as an input indicator having a correlation with the system performance indicator.

A future computer system usage forecasting apparatus according to the example embodiments may be implemented by at least one computer device, and a future computer system usage forecasting method according to the example embodiments may be performed through at least one computer device included in the future system usage forecasting apparatus according to the example embodiments. Here, a computer program according to an example embodiment may be installed and executed on the computer device, and the computer device may perform the future system usage forecasting method according to the example embodiments under control of the executed computer program. The aforementioned computer program may be stored in a computer-readable record medium to computer-implement the future system usage forecasting method in conjunction with the computer device.

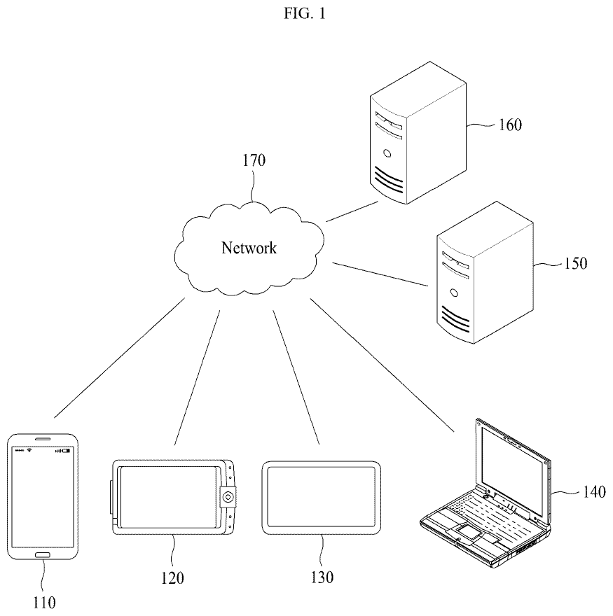

FIG. 1 illustrates a network environment according to at least one example embodiment of the present invention. Referring to FIG. 1, the network environment includes a plurality of electronic devices 110, 120, 130, and 140, a plurality of servers 150 and 160, and a network 170. FIG. 1 is provided as an example only. The number of electronic devices or the number of servers is not limited thereto. Also, the network environment of FIG. 1 describes one example among environments applicable to the example embodiments and an environment applicable to the example embodiments is not limited to the network environment of FIG. 1.

Each of the plurality of electronic devices 110, 120, 130, and 140 may be a fixed terminal or a mobile terminal that is configured as a computer device. For example, the plurality of electronic devices 110, 120, 130, and 140 may be a smartphone, a mobile phone, a navigation device, a computer, a laptop computer, a digital broadcasting terminal, a personal digital assistant (PDA), a portable multimedia player (PMP), a tablet personal computer (PC), and the like. For example, although FIG. 1 illustrates a shape of a smartphone as an example of the electronic device 110, the electronic device 110 used herein may refer to one of various types of physical computer devices capable of communicating with other electronic devices 120, 130, and 140, and/or the servers 150 and 160 over the network 170 in a wireless or wired communication manner.

The communication scheme is not limited and may include a near field wireless communication scheme between devices as well as a communication scheme using a communication network (e.g., a mobile communication network, wired Internet, wireless Internet, a broadcasting network, etc.) includable in the network 170. For example, the network 170 may include at least one of network topologies that include a personal area network (PAN), a local area network (LAN), a campus area network (CAN), a metropolitan area network (MAN), a wide area network (WAN), a broadband network (BBN), and the Internet. Also, the network 170 may include at least one of network topologies that include a bus network, a star network, a ring network, a mesh network, a star-bus network, a tree or hierarchical network, and the like. However, they are provided as examples only.

Each of the servers 150 and 160 may be configured as a computer device or a plurality of computer devices that provides an instruction, a code, a file, content, a service, etc., through communication with the plurality of electronic devices 110, 120, 130, and 140 over the network 170. For example, the server 150 may be a system that provides a service (e.g., integrated log management service) to the plurality of electronic devices 110, 120, 130, and 140 connected over the network 170.

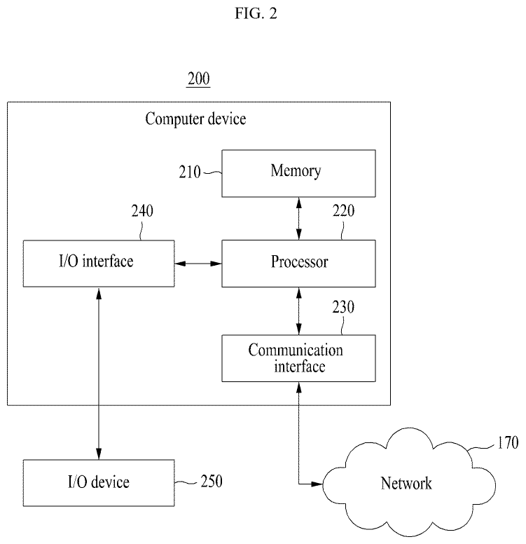

FIG. 2 is a block diagram illustrating a computer device according to at least one example embodiment of the present invention. Each of the plurality of electronic devices 110, 120, 130, and 140 of FIG. 1 or each of the servers 150 and 160 may be implemented by a computer device 200 shown in FIG. 2.

Referring to FIG. 2, the computer device 200 includes a memory 210, a processor 220, a communication interface 230, and an input/output (I/O) interface 240. The memory 210 may include a permanent mass storage device, such as a random access memory (RAM), a read only memory (ROM), and a disk drive, as a non-transitory computer-readable record medium. The permanent mass storage device, such as a ROM and a disk drive, may be included in the computer device 200 as a permanent storage device separate from the memory 210. Also, an OS and at least one program code may be stored in the memory 210. Such software components may be loaded to the memory 210 from another non-transitory computer-readable record medium separate from the memory 210. The other non-transitory computer-readable record medium may include a non-transitory computer-readable record medium, for example, a floppy drive, a disk, a tape, a DVD/CD-ROM drive, a memory card, etc. According to other example embodiments, software components may be loaded to the memory 210 through the communication interface 230, instead of the non-transitory computer-readable record medium. For example, the software components may be loaded to the memory 210 of the computer device 200 based on a computer program installed by files received over the network 170.

The processor 220 may be configured to process instructions of a computer program by performing basic arithmetic operations, logic operations, and I/O operations. The computer-readable instructions may be provided from the memory 210 or the communication interface 230 to the processor 220. For example, the processor 220 may be configured to execute received instructions in response to the program code stored in the storage device, such as the memory 210.

The communication interface 230 may provide a function for communication between the communication apparatus 200 and another apparatus, for example, the aforementioned storage devices, over the network 170. For example, the processor 220 of the computer device 200 may forward a request or an instruction created based on a program code stored in the storage device such as the memory 210, data, and a file, to other apparatuses over the network 170 under control of the communication interface 230. Inversely, a signal, an instruction, data, a file, etc., from another apparatus may be received at the computer device 200 through the communication interface 230 of the computer device 200 over the network 170. For example, a signal, an instruction, data, etc., received through the communication interface 230 may be forwarded to the processor 220 or the memory 210, and a file, etc., may be stored in a storage medium, for example, the permanent storage device, further includable in the computer device 200.

The I/O interface 240 may be a device used for interfacing with an I/O device 250. For example, an input device may include a device, such as a microphone, a keyboard, a mouse, etc., and an output device may include a device, such as a display, a speaker, etc. As another example, the I/O interface 240 may be a device for interfacing with an apparatus in which an input function and an output function are integrated into a single function, such as a touchscreen. In the illustrated embodiment, the I/O device 250 is configured as a single apparatus that communicates with the computer device 200.

According to other example embodiments, the computer device 200 may include a number of components that are greater than or less than the number of components shown in FIG. 2. However, there is no need to clearly illustrate many components according to the related art. For example, the computer device 200 may include at least a portion of the I/O device 250, or may further include other components, for example, a transceiver, a database, etc.

Hereinafter, example embodiments of technology for accurately forecasting and utilizing a future system usage are described.

The example embodiments include technology that may forecast computer system usage for a cluster system environment and technology that may use a computer system usage forecasting result to operate a system.

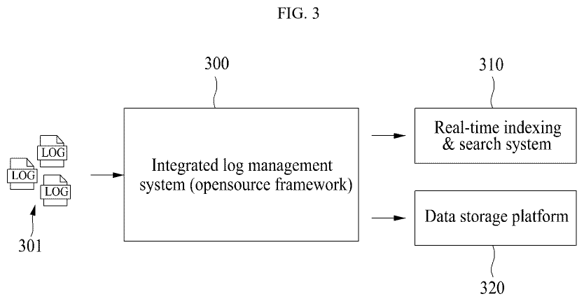

Herein, a cluster refers to a system that receives and processes a large amount of data, and FIG. 3 illustrates an example of a cluster system.

Referring to FIG. 3, an integrated log management system 300 refers to a system that supports receiving logs 301 of various services and storing the same in a real-time indexing & search system 310 and a data storage platform 320. That is, the integrated log management system 300 refers to a service platform that collects the logs 301 generated from various services and use the same to track problems and analyze data.

The integrated log management system 300 is configured as an opensource framework that may process a large amount of data in a distributed environment, and divides or copies the data and then stores the same in multiple disks of multiple clustered computers.

A cluster configuration of the integrated log management system 300 includes a plurality of components and each of the components includes at least one machine (e.g., server).

In the following example embodiments, description is made using the integrated log management system 300 including the plurality of components as a representative example of a cluster. However, without being limited thereto, the example embodiments may be expanded and applied to any system environments in which resources are consumed for input data given from outside.

A computer-implemented future system usage forecasting device may be configured in the computer device 200 according to the example embodiment. The processor 220 of the computer device 200 may be implemented as a component for performing the following future system usage forecasting method. Depending on example embodiments, the components of the processor 220 may be optionally included in or excluded from the processor 220. Also, depending on example embodiments, the components of the processor 220 may be separated or merged for functional representations of the processor 220.

The processor 220 and the components of the processor 220 may control the computer device 200 to perform operations included in the following future system usage forecasting method. For example, the processor 220 and the components of the processor 220 may be implemented to execute an instruction according to a code of at least one program and a code of an operating system (OS) included in the memory 210.

Here, the components of the processor 220 may be representations of different functions performed by the processor 220 according to an instruction provided from a program code stored in the computer device 200.

The processor 220 may read a necessary instruction from the memory 210 to which instructions related to control of the computer device 200 are loaded. In this case, the read instruction may include an instruction for controlling the processor 220 to execute operations described below.

The operations included in the future computer system usage forecasting method described below may be performed in an order that is different from the illustrated order, and some of the operations may be omitted or an additional process may be further included.

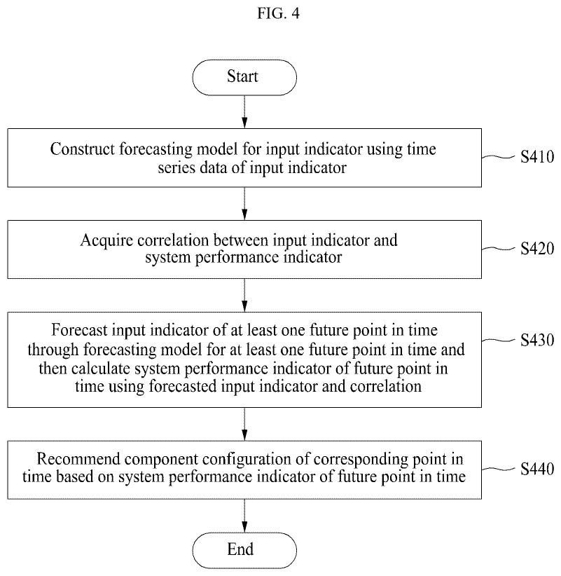

FIG. 4 is a flowchart illustrating an example of a method performed by a computer device according to at least one example embodiment of the present invention.

Referring to FIG. 4, in operation S410, the processor 220 may construct a forecasting model for a predetermined input indicator using time series data of the input indicator. The processor 220 may generate a time series forecasting model for the input indicator by using time series data of the input indicator stored for a relatively long period of time as learning data and by learning the same with a time series forecasting library (e.g., Prophet).

In the example embodiment, the input indicator refers to an indicator to which computer system resources respond and may be selected as an external indicator with few unexpected change factors. Input indicators and output indicators for a computer system may be analyzed over a long period of time and an indicator of which a short-term change is less than a threshold may be selected as an indicator to be used as learning data of the forecasting model. A system performance indicator, such as CPU usage and disk usage, has the characteristic of causing a large change for a short period of time in a situation, such as parameter tuning, rollback, and failure. Therefore, using the system performance indicator as learning data may result in large forecasting errors. Meanwhile, user traffic that is one of the input indicators and log data that is input from outside does not change much for a short period of time. Therefore, when the user traffic is used as learning data of the forecasting model, outliers in the learning data may decrease and accuracy of forecasting may increase. For example, the processor 220 may construct the forecasting model for forecasting a traffic change by loading traffic time series data stored for a long period of time and by training the time series forecasting library to learn the traffic data.

In operation S420, the processor 220 may acquire a correlation between the input indicator and the system performance indicator. The system performance indicator is an output indicator having the characteristic of responding to the input indicator and, for example, may indicate an output indicator that represents system performance, such as CPU usage (number of cores used per second), disk usage (disk capacity in use), and memory usage (memory capacity in use). The system performance indicators, such as CPU usage, disk usage, and memory usage, are related to user traffic that is one of the input indicators. For example, a correlation between search traffic and CPU/disk usage of a search server may be utilized for a search service, and a correlation between use traffic, such as blog search, posting, and neighbor notification, and CPU/disk usage of each blog server may be utilized for a blog service. In the case of a shopping service, a correlation between use traffic, such as shopping search, purchase, and delivery inquiry, and CPU/disk usage of each shopping server may be utilized. The processor 220 may retrieve short-term (e.g., 3 days) time series data of each of the input indicator and the system performance indicator and may derive the correlation between the input indicator and the system performance indicator through a linear regression model. Although it is described in the example embodiment that the correlation between the input indicator and the system performance indicator is derived through linear regression, it is not limited thereto and any methods capable of defining the correlation between the input indicator and the system performance indicator from time series data may be applied.

In operation S430, the processor 220 may forecast the input indicator associated with at least one future point in time (e.g., 7 days in the future and 30 days in the future) through the forecasting model for the at least one future point in time and may calculate the system performance indicator of the future point in time using the forecasted input indicator and the correlation acquired in operation S420. The example embodiment may forecast a future change in the input indicator with few unexpected change factors through the forecasting model constructed in operation S410, rather than directly forecasting the system performance indicator with many unexpected change factors. Here, the processor 220 may calculate the system performance indicator of the future point in time by applying the correlation between the input indicator and the system performance indicator to the input indicator of the future point in time forecasted with the forecasting model. That is, the processor 220 may initially forecast the change in the input indicator for each future time through time series forecasting and may forecast the future change in the system performance indicator using the forecasted input indicator and the correlation acquired in advance.

In operation S440, the processor 220 may recommend a component configuration of a corresponding point in time based on the system performance indicator of the future point in time. For example, the processor 220 may forecast the system performance indicator of the future point in time for each component constituting a cluster in a situation in which the trend for the input indicator is maintained and may recommend a device of the corresponding component to be additionally installed if a future forecast value of the system performance indicator exceeds a critical value range for the system performance indicator and may recommend the device of the corresponding component to be partially removed if the future forecast value of the system performance indicator is less than the critical value range. To construct an efficient cluster, the processor 220 may calculate and recommend the number of machines to be additionally installed or removed based on a future change forecast value of the system performance indicator. As another example, when a forecast value of the input indicator that may occur due to new connection through addition of a cluster is given, the processor 220 may recommend the number of machines for each component of the cluster. When constructing a new cluster, the processor 220 may calculate and recommend the number of machines required for each component.

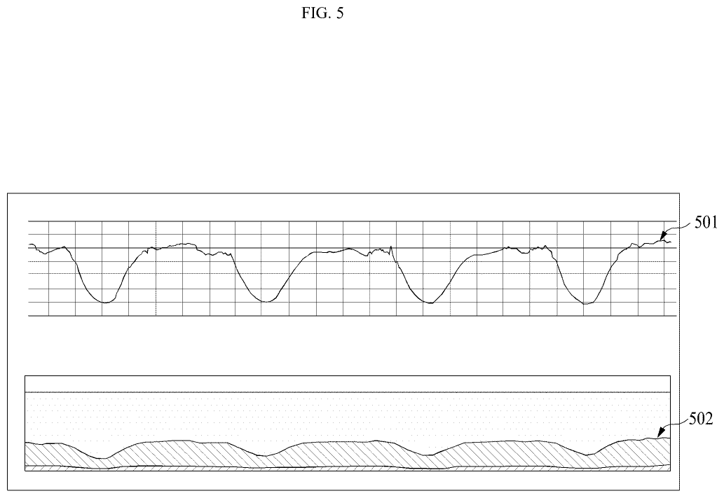

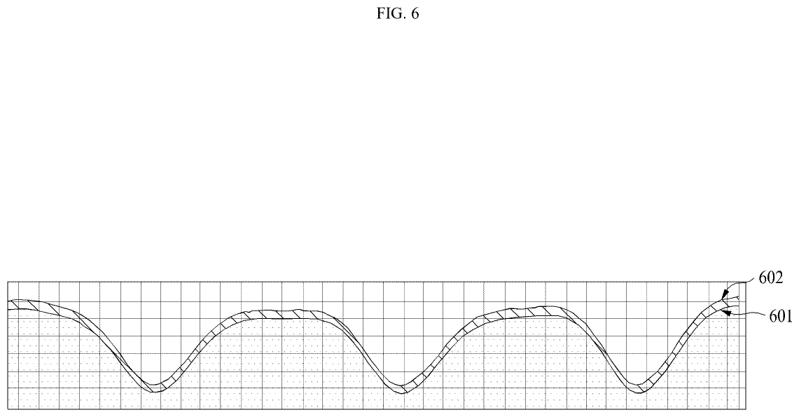

FIGS. 5 and 6 illustrate examples of an input indicator and a system performance indicator according to at least one example embodiment of the present invention.

Most services are tailored to the resource usage of each machine and have a need to provide a stable service by further installing machines when the resource usage is too high and, on the contrary, have a need to save operating cost by excluding some of the existing machines when the resource usage is too low.

For stable system operation and reduction in operational resources, there is a need to elaborately forecast the future system usage. To this end, it is important to construct a model with high accuracy of forecasting and to consider a correlation between an input indicator and a system performance indicator.

Referring to FIG. 5, in the example embodiment, user traffic 501 indicating a log input amount (e.g., byte/s (BPS), query/s (QPS)) by service users may be utilized as the input indicator, and CPU usage 502 of a component responding to the user traffic 501 may be utilized as the system performance indicator. According to time series data of the user traffic 501 and the CPU usage 502 stored for a long period of time, it can be seen that the user traffic 501 has a very high relationship with the CPU usage 502.

Referring to FIG. 6, the CPU usage 502 and disk usage 602, correspond to the system performance indicator that responds to the user traffic 501. It can be verified that a value 601 acquired by integrating a BPS corresponding to the user traffic 501 over time based on time series data of the user traffic 501 and the disk usage 602 stored for a long period of time is similar to the disk usage 602. From this, it can be known that the user traffic 501 has a very high relationship with the disk usage 602.

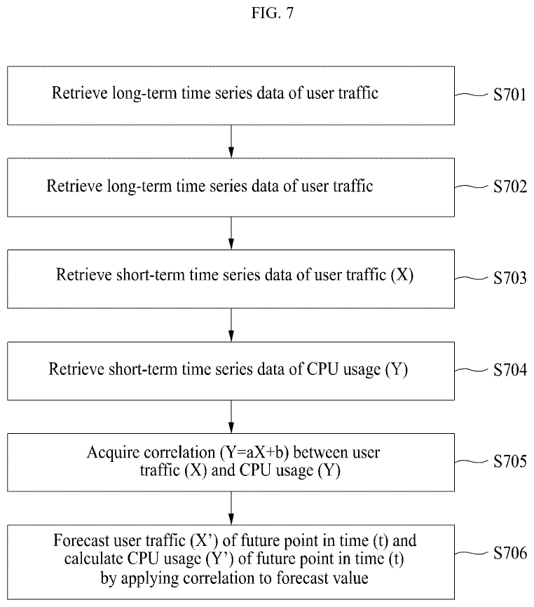

FIG. 7 is a flowchart illustrating a CPU usage forecasting process according to at least one example embodiment.

Referring to FIG. 7, in operation S701, the processor 220 may retrieve time series data of user traffic stored for a relatively long period of time as learning data of a forecasting model.

In operation S702, the processor 220 may generate a time series forecasting model for the user traffic by training a time series forecasting library (e.g., Prophet) to learn traffic data retrieved in operation S701.

In operation S703, the processor 220 may retrieve time series data of user traffic (X) stored for a relatively short period of time compared to model learning data.

In operation S704, the processor 220 may retrieve time series data of CPU usage (Y) stored for a relatively short period of time compared to the model learning data.

In operation S705, the processor 220 may acquire a correlation (Y=aX+b) between the user traffic and the CPU usage through a linear regression model using the time series data of the user traffic and the time series data of the CPU usage retrieved in operations S703 and S704, respectively. Here, “a” denotes a linear regression coefficient value, “b” denotes a linear regression intercept value, and “a” and “b” may be determined through linear regression for short-term time series data. For example, time series data stored for 3 days may be used to determine “a” and “b,” and the corresponding period of time may be willingly adjusted.

In the correlation between the user traffic and the CPU usage, “b” may be determined as a value close to 0. Setting “b” to 0 may have a meaning, but the CPU usage may not be 0 at all times in an idle state, so “b” is not set to 0.

In operation S706, the processor 220 may forecast user traffic (X′) of a future point in time (t) through the time series forecasting model constructed in operation S702 and then, may calculate CPU usage (Y′) of the future point in time (t) using a future forecast value (X′) for the user traffic and the correlation acquired in operation S705.

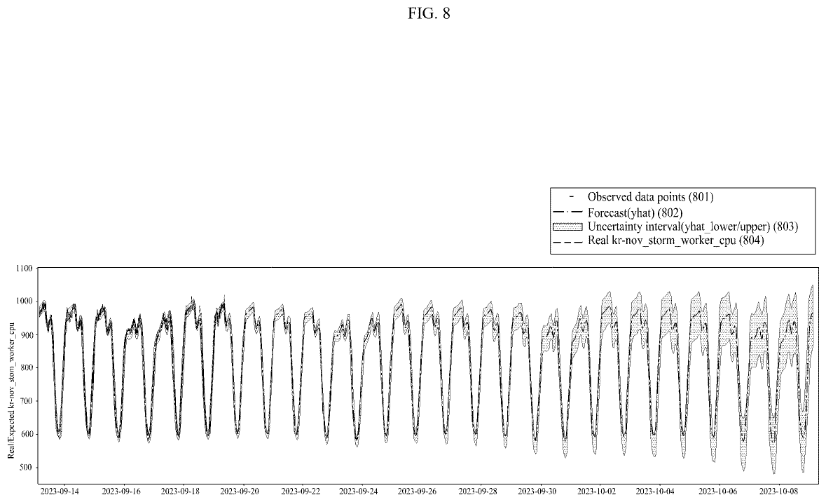

When additionally installing or removing a machine with respect to a component or when performing server tuning, a great change may occur in actual CPU usage for a short period of time. In the case of using this CPU usage as learning data, the change may result in great forecasting errors. However, user traffic rarely changes in a short period of time. The example embodiment may construct the time series forecasting model using user traffic with few unexpected change factors. Also, by acquiring the correlation between the user traffic and the CPU usage of the machine, a relationship regarding which traffic uses how much CPU may be derived. Through the forecasting model for user traffic, it is possible to forecast how much (Δ) the user traffic (X) may change in the future. Further, from the correlation between the user traffic and the CPU usage, it is possible to forecast how much (aΔ) CPU may be used in response to a change in the user traffic (X) by Δ. FIG. 8 illustrates an example of forecasting CPU usage according to at least one example embodiment. In FIG. 8, 801 represents CPU usage (Y) according to a correlation (aX+b) with user traffic, 802 represents a value (Y′) acquired by learning the user traffic (X) and by multiplying a and adding b with respect to a value (X′) forecasted by the time series forecasting model, 803 represents forecasting errors (upper/lower) of the time series forecasting model, and 804 represents actually measured CPU usage.

The forecasting model training process (S702) and the correlation analysis process (S705) may be performed at regular time intervals. Here, when the user traffic (X) is added after a previous forecast point in time, the forecasting model may be updated by periodically performing model training to reflect the added data to the forecasting model. Also, although the user traffic (X) is the same, the CPU usage (Y) may increase or decrease due to parameter tuning or rollback. To reflect this change in the forecasting process (S706), the correlation between the user traffic (X) and the CPU usage (Y) may be periodically acquired again. For example, in the relationship (Y=aX+b) between the user traffic (X) and the CPU usage (Y), although the traffic is the same, the correlation may change from a=0.1 and b=1 before tuning to a=0.05 to b=1 to after tuning, according to parameter tuning. By periodically updating the correlation between the user traffic (X) and the CPU usage (Y), it is possible to more accurately forecast the CPU usage of the future point in time in response to the change in the relationship.

In the same manner as the CPU usage forecasting process described through FIG. 7, it is possible to forecast a change in the future point in time for the disk usage that is another type of the system performance indicator. However, when acquiring a correlation between the user traffic and the disk usage, the correlation with the disk usage may be acquired by using a value acquired by retrieving and integrating short-term time series data of the user traffic over time.

The correlation between the user traffic (X) and the disk usage (Y) may be defined as disk usage (Y)=a×[integral value of user traffic (X) stored for retention hour×number of copies]+b. In the relationship between the user traffic and the disk usage, a may be determined as a value close to 1. Depending on example embodiments, it may be meaningful to set a to 1 and to set b to 0.

By acquiring the correlation between the user traffic and the disk usage, a relationship regarding how much disk is used for which traffic may be derived. Through the forecasting model for the user traffic, it is possible to forecast how much the user traffic (X) may change in the future. Further, from the correlation between the user traffic and the disk usage, it is possible to forecast how much (aΔ) CPU may be used if the user traffic (X) changes by Δ.

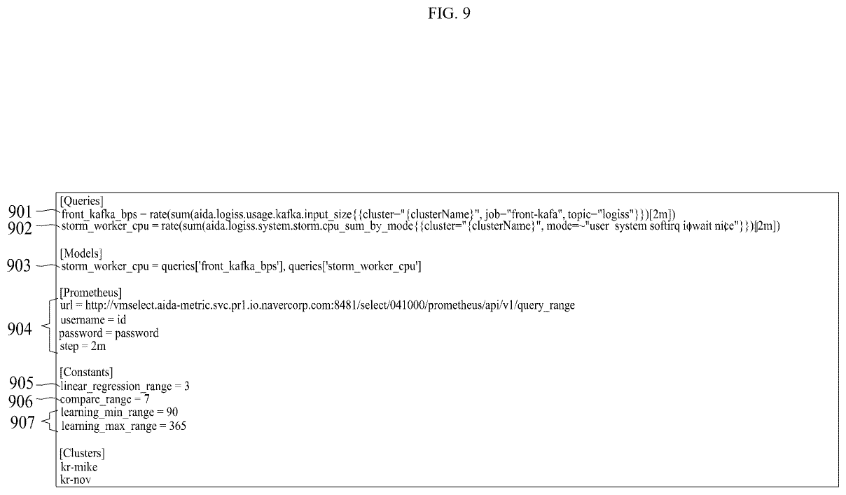

FIG. 9 illustrates an example of a configuration file for forecasting resource usage according to at least one example embodiment. FIG. 9 illustrates a configuration file for forecasting resource availability of a system called Logiss, which is an integrated log management platform released by Naver, as an example of a cluster. The aforementioned future system usage forecasting technology of the present invention may be abstracted as in the configuration file of FIG. 9 to be available in other services and to make it possible to add a model.

For example, referring to FIG. 9, to forecast Logiss system availability, a query file 901 that calculates user traffic, a query file 902 that calculates CPU usage, a model file 903 that analyzes a correlation between the user traffic and the CPU usage, a file 904 that sets a query execution target of which resource availability is to be forecasted, an integer representing a section 905 for performing linear regression of the two query files 901 and 902 specified as the model file 903, an integer representing a period 906 used to compare a value (Y=aX+b) acquired through linear regression with the real CPU usage, and an integer representing minimum/maximum range 907 of learning data to be used for forecasting traffic may be included. The configuration file for forecasting the disk usage may also be similar or identical to the configuration file of FIG. 9, and high reusability with contents of the abstracted configuration file may be provided.

In short, the correlation between the user traffic (X) and the CPU/disk usage (Y) may be acquired from time series data stored for a short period of time and, through this, the change in the CPU/disk usage according to the change in future traffic may be calculated. Here, it is possible to reduce outliers in learning data by forecasting only the change in traffic usage and then calculating the change in the CPU/disk usage according to the change in traffic usage forecasted using the correlation (coefficient and intercept), without directly forecasting the CPU usage or the disk usage.

When an indicator with few unexpected change factors is selected as an input indicator and its correlation with a system performance indicator is acquired, the correlation may be applied to various services. Here, to apply resource usage forecasting to various services, it is possible to abstract settings for a query, a model, and a TSDB target.

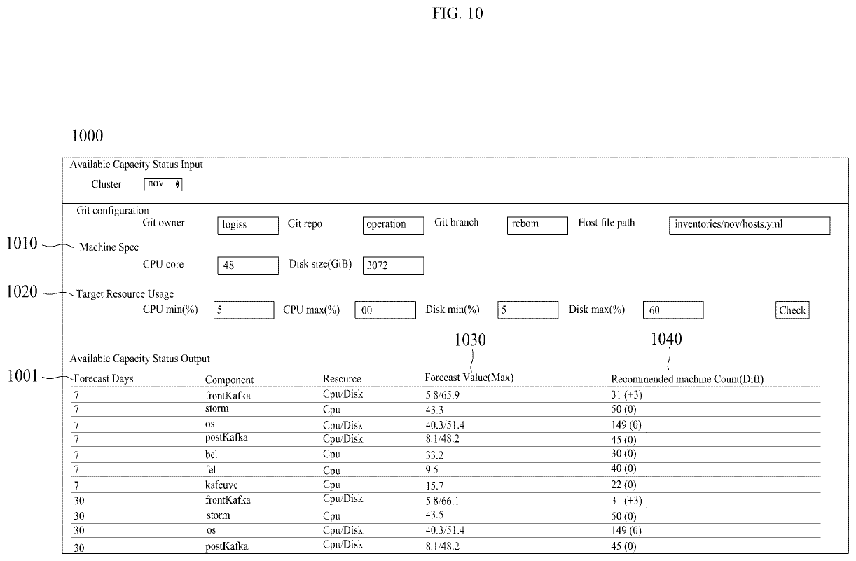

FIGS. 10 to 12 illustrate examples of recommending a component configuration in forecasting resource usage according to at least one example embodiment.

The processor 220 may calculate a future system performance indicator using a correlation between a forecasting model for an input indicator and the input indicator for each component constituting a cluster and then, may recommend each component configuration based on the future system performance indicator.

For convenience of resource usage forecasting for each component, each component may be quantified as a unit system. For example, 4 CPU, 500 G (disk), 32 G (memory) capacity may be defined as a single unit system and the total resources required may be expressed by the number of quantified unit systems.

Component configuration recommendation may include recommendation content on the number of machines to be installed or removed when CPU/disk usage of the future point in time is forecasted to exceed or be less than a predetermined critical range and recommendation content on the number of machines required to withstand certain traffic (e.g., maximum 800 MiB/s+10 TiB daily input amount) with a certain level of system resources (e.g., such that maximum usage is CPU 50%, disk 70%) based on the correlation between the user traffic and the CPU/disk usage.

The processor 220 may provide recommendation information on a component configuration through an administrator screen in conjunction with a system that automates an operation, such as installation or removal of a machine for each component constituting the cluster.

FIG. 10 shows an available capacity status administrator screen 1000 that recommends a component configuration according to the available capacity status of the integrated log management system 300. Referring to FIG. 10, when specification information 1010 and target resource usage 1020 of a specific cluster are input through the available capacity status administrator screen 1000, the processor 220 may recommend a forecast value 1030 for resource usage of a future point in time 1001 for each component and the number of machines required for each component according to the forecast value 1030 compared to the target resource usage 1020. Therefore, if machine specifications, such as the number of CPU cores and disk capacity, are input, it is possible to calculate and recommend the number of machines that need to be installed to suit the computer usage within the target range desired by an administrator in preparation for a change in future traffic usage. For example, a machine operation automation system may receive, through API, the recommended number of machines to be installed or removed when targeting the system usage within 7 days or 30 days forecasted by this system to be maximum 60% or less and minimum 5% or more, and may appropriately adjust and operate the component configuration.

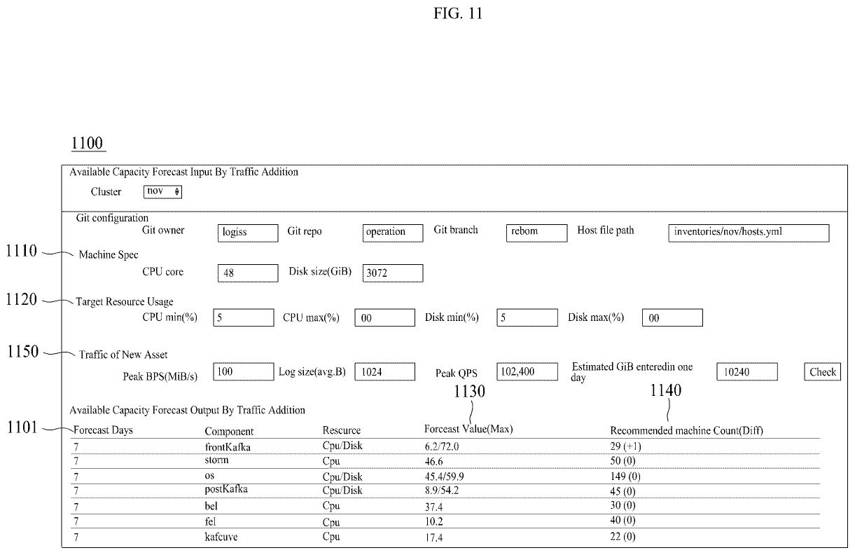

FIG. 11 shows an available capacity forecasting administrator screen 1100 that recommends a component configuration in forecasting the available capacity by traffic addition of the integrated log management system 300. Referring to FIG. 11, when specification information 1110 and target resource usage 1120 of a specific cluster and a traffic size 1150 to be added are input through the available capacity forecasting administrator screen 1100, the processor 220 may recommend a forecast value 1130 of a future point in time 1101 for resource usage according to traffic addition for each component and the number of machines 1140 required for each component according to the forecast value 1130 compared to the target source usage 1120. Even in an environment in which new traffic is added, it is possible to calculate and recommend the number of machines to be installed to suit resource usage within the target range desired by the administrator, in preparation for the change in the future traffic usage.

Although the example embodiment describes an example of forecasting the system performance indicator for each component for the future point in time 1001, 1101 and recommending the component configuration of the corresponding point in time, it is not limited thereto. Depending on example embodiments, it is possible to provide a user interface (UI) capable of forecasting a system performance indicator corresponding to each future point in time of a predetermined period of time and allowing a user to verify a future point in time at which a forecast value of the system performance indicator falls outside the critical range (e.g., target resource usage) (i.e., a point in time at which the forecast value is expected to exceed or fall less than the critical value range). That is, in the process of utilizing the result of forecasting system availability, it is possible to guide the administrator of the future point in time at which the system availability falls outside the predetermined critical range and to support the administrator to adjust the number of machines for each component in advance in a time zone with low traffic.

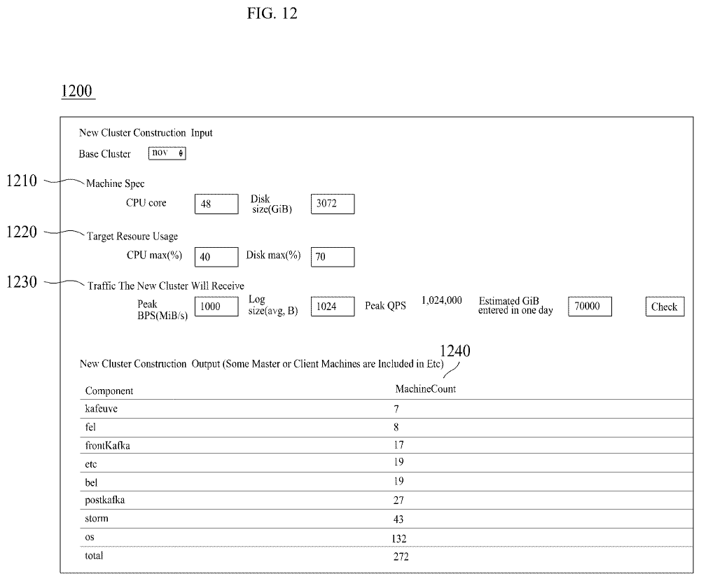

FIG. 12 shows a new cluster construction administrator screen 1200 that recommends a component configuration for constructing a new cluster of the integrated log management system 300. Referring to FIG. 12, when specification information 1210 and target resource usage 1220 of a cluster to be added, and scale of traffic to be received (e.g., an amount of traffic value to be received at peak and an amount of traffic to be input for a day) 1230 are input, the processor 220 may recommend the number of machines 1240 required for each component capable of processing the scale of traffic scale to be received 1230 within the target resource usage 1220. Based on the correlation of “CPU usage (number of cores used per second)=aX(traffic value at peak)+b,” a and b may be calculated for each component. When a traffic value at peak that the cluster will receive is input, the maximum CPU usage may be calculated and the number of cores used per second may be calculated. Therefore, it is possible to calculate and recommend the number of machines to be installed to lower the maximum CPU usage below the target range. Likewise, based on the correlation of “disk usage=aX (traffic integral valueXnumber of copies)+b,” a traffic integral value may be calculated through an amount of traffic that the cluster may receive for a day and total disk usage may be calculated accordingly. This makes it possible to calculate the number of machines to be installed to lower the disk usage below the target range.

According to example embodiments, it is possible to construct a forecasting model for forecasting a change in an input indicator by training a time series forecasting model to learn an input indicator with few unexpected change factors as an input indicator having correlation with a system performance indicator, thereby reducing outliers in learning data and increasing accuracy of forecasting. Also, according to example embodiments, it is possible to easily and simply forecast a future system performance only with an input indicator by forecasting a change in an input indicator through a forecasting model and by calculating a system performance indicator according to correlation using a forecast value of the input indicator, rather than directly forecasting the system performance indicator. Also, according to example embodiments, it is possible to stably maintain and manage a system by utilizing a future system performance indicator in conjunction with a system that automates a resources operation, such as installation or exclusion of a machine and to save operational resources for calculating the number of machines when configuring a new cluster.

The apparatuses described herein may be implemented using hardware components, software components, and/or the combination of the hardware components and the software components. For example, the apparatuses and the components described herein may be implemented using one or more general-purpose or special purpose computers, such as, for example, a processor, a controller, an arithmetic logic unit (ALU), a digital signal processor, a microcomputer, a field programmable gate array (FPGA), a programmable logic unit (PLU), a microprocessor or any other device capable of responding to and executing instructions in a defined manner. A processing device may run an operating system (OS) and one or more software applications that run on the OS. The processing device also may access, store, manipulate, process, and create data in response to execution of the software. For purpose of simplicity, the description of a processing device is used as singular; however, one skilled in the art will appreciate that the processing device may include multiple processing elements and/or multiple types of processing elements. For example, the processing device may include multiple processors or a processor and a controller. In addition, different processing configurations are possible, such as parallel processors.

The software may include a computer program, a piece of code, an instruction, or some combinations thereof, for independently or collectively instructing or configuring the processing device to operate as desired. Software and/or data may be embodied permanently or temporarily in any type of machine, component, physical equipment, virtual equipment, computer storage medium or device, or in a propagated signal wave capable of providing instructions or data to or being interpreted by the processing device. The software also may be distributed over network coupled computer systems so that the software is stored and executed in a distributed fashion. The software and data may be stored by one or more computer readable storage mediums.

The methods according to the above embodiments may be recorded in non-transitory computer-readable media including program instructions executable through various computer methods. Here, the media may continuously store computer-executable programs or may transitorily store the same for execution or download. Also, the media may be various types of recording devices or storage devices in a form in which one or a plurality of hardware components are combined. Without being limited to a media directly connected to a computer system, the media may be distributed over the network. Examples of non-transitory computer-readable media include magnetic media such as hard disks, floppy disks, and magnetic tapes; optical media such as CD ROM disks and DVD; magneto-optical media such as floptical disks; and hardware devices that are specially designed to store and perform program instructions, such as read-only memory (ROM), random access memory (RAM), flash memory, and the like. Examples of other media may include recording media and storage media managed by an app store that distributes applications or a site, a server, and the like that supplies and distributes other various types of software.

The foregoing description has been provided for purposes of illustration and description. It is not intended to be exhaustive or to limit the disclosure. Individual elements or features of a particular example embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A future computer system usage forecasting method of a computer device comprising at least one processor, the method comprising:
constructing, by the at least one processor, a forecasting model for an input indicator using time series data of the input indicator stored for a first period of time;
acquiring, by the at least one processor, a correlation between the input indicator and a system performance indicator using time series data of the input indicator and the system performance indicator stored for a second period of time;
forecasting, by the at least one processor, the input indicator associated with at least one future point in time through the forecasting model for the at least one future point in time; and
calculating, by the at least one processor, the system performance indicator at the future point in time using the forecasted input indicator and the correlation.

2. The method of claim 1, wherein the input indicator is selected as an indicator of which a change for a third period of time is less than a threshold among indicators to which system resources respond.

3. The method of claim 1, wherein user traffic corresponding to log data that is input from the outside is used as the input indicator, and
CPU usage or disk usage is used as the system performance indicator.

4. The method of claim 1, wherein the acquiring of the correlation comprises acquiring the correlation between the input indicator and the system performance indicator through a linear regression model.

5. The method of claim 1, wherein the acquiring of the correlation comprises determining a linear regression coefficient value and a linear regression intercept value through linear regression on time series data of the second period of time.

6. The method of claim 5, wherein the linear regression intercept value is determined as a value close to 0.

7. The method of claim 1, wherein the constructing of the forecasting model comprises updating the forecasting model using data stored after a previous forecast point in time for the input indicator.

8. The method of claim 1, wherein the acquiring of the correlation comprises updating the correlation between the input indicator and the system performance indicator at certain time intervals.

9. The method of claim 1, wherein the acquiring of the correlation comprises acquiring the correlation between the input indicator and the system performance indicator using a value acquired by integrating time series data of the input indicator over time according to a type of the system performance indicator.

10. The method of claim 1, further comprising:
recommending, by the at least one processor, a component configuration of the future point in time using the calculated system performance indicator.

11. The method of claim 10, wherein the calculating of the system performance indicator of the future point in time comprises calculating the system performance indicator of the future point in time for each component constituting a cluster, and
the recommending of the component configuration of the future point in time comprises calculating and recommending the number of machines of a corresponding component based on the system performance indicator of the future point in time for each component.

12. The method of claim 1, further comprising:
calculating, by the at least one processor, the system performance indicator for each component constituting a new cluster using an input indicator scheduled to be received and the correlation when the input indicator scheduled to be received is given to construct the new cluster; and
calculating, by the at least one processor, and recommending the number of necessary machines for each component based on the system performance indicator for each component.

13. The method of claim 1, further comprising:
providing, by the at least one processor, a point in time in the future at which the calculated system performance indicator falls outside a critical value range.

14. A non-transitory computer-readable record medium storing a computer program to execute the future system usage forecasting method of claim 1 on the computer device.

15. A computer device comprising:
at least one processor configured to execute computer-readable instructions, wherein the at least one processor causes the computer device to:
construct a forecasting model for an input indicator using time series data of the input indicator stored for a first period of time,
acquire a correlation between the input indicator and a system performance indicator using time series data of the input indicator and the system performance indicator stored for a second period of time,
forecast the input indicator associated with at least one future point in time through the forecasting model for the at least one future point in time, and
calculate the system performance indicator at the future point in time using the forecasted input indicator and the correlation.

16. The computer device of claim 15, wherein the input indicator is selected as an indicator of which a change for a third period of time is less than a threshold among indicators to which system resources respond.

17. The computer device of claim 15, wherein the at least one processor causes the computer device to,
update the forecasting model using data stored after a previous forecast point in time for the input indicator, and
update the correlation between the input indicator and the system performance indicator at certain intervals.

18. The computer device of claim 15, wherein the at least one processor causes the computer device to acquire the correlation between the input indicator and the system performance indicator using a value acquired by integrating time series data of the input indicator over time in some cases according to a type of the system performance indicator.

19. The computer device of claim 15, wherein the at least one processor causes the computer device to:
calculate the system performance indicator at the future point in time for each component constituting a cluster, and
calculate and recommend the number of machines of a corresponding component based on the system performance indicator at the future point in time for each component.

20. The computer device of claim 15, wherein the at least one processor causes the computer device to provide a point in time in the future at which the calculated system performance indicator falls outside a critical value range.
